(19) United States
(12) Patent Application Publication
(10) Pub. No.: US 2026/0177041 A1
(43) Pub. Date: Jun. 25, 2026

(54) ACTUATOR AND ACTUATOR DRIVE METHOD

(71) Applicant: SONY GROUP CORPORATION, TOKYO (JP)

(72) Inventors: TAKAHIRO OGAWA, TOKYO (JP); OHMI FUCHIWAKI, TOKYO (JP); KANTA IIZUKA, TOKYO (JP); SHUJI FUJITA, TOKYO (JP); YUKITO INOUE, TOKYO (JP); TOMOYA TAKEI, TOKYO (JP); YOHEI KURODA, TOKYO (JP); AYAKA HIYAMA, TOKYO (JP)

(21) Appl. No.: 19/127,415

(22) PCT Filed: Oct. 24, 2023
(86) PCT No.: PCT/JP2023/038249

§ 371 Date: May 6, 2025

(30) Foreign Application Priority Data
Nov. 11, 2022 (JP) 2022-181265

(51) Int. Cl. F03G 7/06

(52) U.S. Cl. CPC F03G 7/06143; F03G 7/0614; F03G 7/062; F03G 7/0636

(57) ABSTRACT

The present technology relates to an actuator and an actuator drive method that are capable of cooling an actuator (SMA actuator) using an shape memory alloy (SMA) by means of an stand-alone cooling mechanism. A wire is formed of a shape memory alloy, the wire is arranged to pass through a hollow portion of a tubular member, and a refrigerant, which is a fluid, is stored in the hollow portion.

### TECHNICAL FIELD

The present technology relates to an actuator and an actuator drive method, and in particular relates to an actuator and an actuator drive method that are capable of cooling an actuator (SMA actuator) using an shape memory alloy (SMA) by means of an stand-alone cooling mechanism.

### BACKGROUND ART

Non-Patent Literature 1 shows that a structure covering the periphery of the SMA with a liquid metal results in faster cooling than natural cooling after energization and heating.

### CITATION LIST

### Non-Patent Literature

Non-Patent Literature 1: Darren Hartl, Jacob Mingear, Brent Bielefeldt, John Rohmer, Jessica Zamarripa, Alaa Elwany “Towards High-Frequency Shape Memory Alloy Actuators Incorporating Liquid Metal Energy Circuits,” Shape Memory and Super elasticity 3, 457-466(2017)

### DISCLOSURE OF INVENTION

### Technical Problem

It is desirable to be capable of installing an SMA actuator in a compact device. The SMA actuator requires an external apparatus that generates flow in the surrounding medium (refrigerant) for its cooling, but the external apparatus prohibits the installation of the SMA actuator in the compact device. Therefore, it is desirable to be capable of cooling the SMA actuator by means of a stand-alone cooling function, eliminating the need for an external apparatus.

The present technology has been made in view of such circumferences to be capable of cooling an actuator using an SMA by means of an stand-alone cooling mechanism.

### Solution to Problem

An actuator according to a first aspect of the present technology is an actuator including: a wire formed of a shape memory alloy; a tubular member in which the wire is arranged to pass through a hollow portion; and a refrigerant that is a fluid stored in the hollow portion.

In the actuator according to the first aspect of the present technology, a wire is formed of a shape memory alloy, the wire is arranged to pass through a hollow portion a tubular member, and a refrigerant, which is a fluid, is stored in the hollow portion.

An actuator drive method according to a second aspect of the present technology is an actuator drive method for driving an actuator including a wire formed of a shape memory alloy, a tubular member in which the wire is arranged to pass through a hollow portion, and a refrigerant that is a fluid stored in the hollow portion, including: a first step of energizing the wire; a second step of energizing off the wire when the wire undergoes a reverse transformation; a third step of increasing a load on the wire; and a fourth step of removing the increase in load in the third step when the wire undergoes a transformation.

In the actuator drive method according to the second aspect of the present technology, an actuator drive method for driving an actuator including a wire formed of a shape memory alloy, a tubular member in which the wire is arranged to pass through a hollow portion, and a refrigerant that is a fluid stored in the hollow portion is energized, the wire is energized off when the wire undergoes a reverse transformation, a load on the wire is increased, and the increase in load is removed when the wire undergoes a transformation.

### BRIEF DESCRIPTION OF DRAWINGS

FIG. 1 A perspective view showing a configuration example of a first embodiment of an SMA actuator to which the present technology has been applied.

FIG. 2 A cross-sectional view showing a configuration example of the first embodiment of the SMA actuator to which the present technology has been applied.

FIG. 3 A cross-sectional view showing a configuration example of a second embodiment of the SMA actuator to which the present technology has been applied.

FIG. 4 A cross-sectional view showing a configuration example of a third embodiment of the SMA actuator to which the present technology has been applied.

FIG. 5 A cross-sectional view showing a configuration example of a fourth embodiment of the SMA actuator to which the present technology has been applied.

FIG. 6 A cross-sectional view showing a configuration example of a fifth embodiment of the SMA actuator to which the present technology has been applied.

FIG. 7 A cross-sectional view showing a configuration example of a sixth embodiment of the SMA actuator to which the present technology has been applied.

FIG. 8 A cross-sectional view showing a configuration example of a seventh embodiment of the SMA actuator to which the present technology has been applied.

FIG. 9 A cross-sectional view showing a configuration example of an eighth embodiment of the SMA actuator to which the present technology has been applied.

FIG. 10 A cross-sectional view showing a configuration example of a ninth embodiment of the SMA actuator to which the present technology has been applied.

FIG. 11 A graph showing differences in responsiveness depending on the type of refrigerant of the SMA actuator.

FIG. 12 A diagram showing changes in heating time, cooling time, and maximum operating frequency depending on a magnitude of preload applied to the SMA actuator.

FIG. 13 A diagram illustrating actual measurement results of relationships between temperature and displacement percentage of the SMA wire depending on a load on the SMA wire.

FIG. 14 A diagram illustrating actual measurement results of relationships between temperature and displacement percentage of the SMA wire depending on the load on the SMA wire.

FIG. 15 A block diagram showing a configuration example of a control system that switches a load on the SMA actuator for increasing an operating speed.

FIG. 16 A flow diagram showing a procedure example of driving the SMA actuator.

### MODE(S) FOR CARRYING OUT THE INVENTION

Hereinafter, embodiments of the present technology will be described with reference to the drawings.

### SMA Actuator According to Present Embodiment

### First Embodiment of SMA Actuator

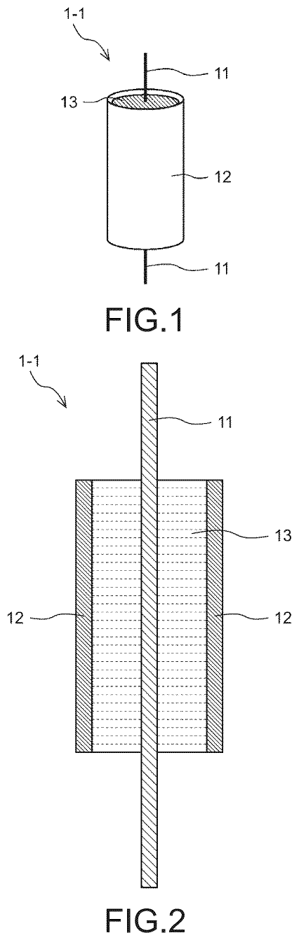

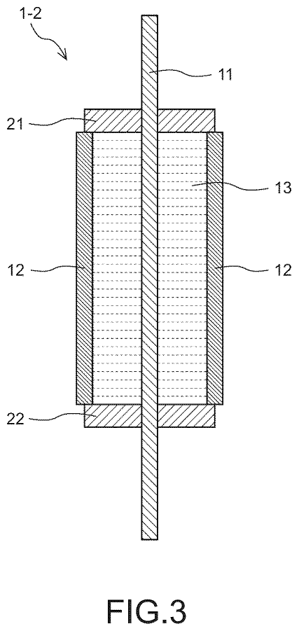

FIGS. 1 and 2 are a perspective view and a cross-sectional view showing a configuration example of a first embodiment of the SMA actuator to which the present technology has been applied. In FIGS. 1 and 2, an SMA actuator 1-1 according to the first embodiment includes an SMA wire 11, an elastic tube 12, and a refrigerant 13. The SMA wire 11 is a linear wire member formed of a shape memory alloy. It should be noted that the SMA wire 11 is not limited to the linear shape, and the SMA wire 11 may have a shape wound like a coil or may have any other shape. It should be noted that FIG. 2 is a cross-sectional view of the SMA actuator 1-1 taken along a plane along an axis line direction of the SMA wire 11 (The same applies to cross-sectional views in FIGS. 3 to 5, FIG. 9, and FIG. 10). The shape memory alloy as a material of the SMA wire 11 becomes a crystal structure called austenite phase at a temperature higher than a predetermined temperature (shape recovery temperature). When the shape memory alloy in the austenite phase is cooled, it undergoes a transformation into a martensite phase. In the martensite phase, the shape memory alloy is easily deformed by an external force. When the deformed shape memory alloy is heated to a temperature higher than the shape recovery temperature, the crystal structure of the shape memory alloy recovers to the austenite phase, so the shape memory alloy recovers to the memorized shape. As the shape memory alloy used as the SMA wire 11, Ni-Tian alloy can be principally employed, but any type of shape memory alloy, such as a Cu—Zn-Alan alloy, may be employed. Electrodes (not shown) of a circuit (power supply) that applies an electric current or voltage are connected to the vicinity of both ends of the SMA wire 11 so that the SMA wire 11 can be energized and energized off. The SMA wire 11 is heated by self-heating to contract to the memorized shape when it is energized. The SMA wire 11 is cooled (heat dissipation) to expand when it is energized off. The SMA wire 11 is arranged to pass through a hollow portion of the elastic tube 12.

The elastic tube 12 is a tubular member formed in a tubular shape and capable of expanding and contracting. The elastic tube 12 is, for example, formed in a thin and long cylindrical shape and has a space (hollow portion) extending in the axis line direction. It should be noted that in FIGS. 1 and 2, a longitudinal length of the elastic tube 12 is drawn shorter than it actually is. An outer circumferential surface (outer circumferential surface of the tubular body) and an inner circumferential surface (inner circumferential surface of the elastic tube 12, in other words, a boundary surface between the tubular body and the hollow portion) may have any shape. The elastic tube 12 is formed of an elastic material. For example, silicone resin, urethane resin, latex, polyimide resin, acrylic resin, bismaleimide resin, epoxy resin, polyethylene glycol resin, and the like are used as the material of the elastic tube 12. The SMA wire 11 is inserted in the hollow portion of the elastic tube 12 and the refrigerant 13 is stored in the hollow portion of the elastic tube 12. It should be noted that the elastic tube 12 is fixed to a housing member (not shown) together with the both ends of the SMA wire 11 or fixed to the SMA wire 11 or the like, and expands and contracts in conjunction with the SMA wire 11. It should be noted that the elastic tube 12 does not need to be fixed to the SMA wire 11 and may be free to move.

The refrigerant 13 is a fluid different from air and is a fluid (gas or liquid) having a higher thermal conductivity than at least air. For example, a liquid metal is used as the refrigerant 13. A liquid metal including an eutectic alloy such as a gallium-indium alloy or a gallium-indium-tin alloy (Galinstan (registered trademark) ), a single element such as gallium, tin, indium, amalgam, mercury, rubidium, francium, or nickel, or a mixed composition of some of these elements is used as the liquid metal. Moreover, the refrigerant 13 may be a liquid (including semi-solid) other than a liquid metal, such as heat-dissipating grease or water, or may be a gas, such as hydrogen or fluorine. It should be noted that the both ends of the elastic tube 12 are sealed as appropriate so that the refrigerant 13 does not leak out of end portions of the elastic tube 12 (see the second embodiment in FIG. 3 or the like). In a case where the refrigerant 13 has a high surface tension like the liquid metal and the hollow portion of the elastic tube 12 has a diameter that causes a capillary phenomenon, even if the openings at the both ends of the elastic tube 12 are not sealed, the refrigerant 13 is maintained in a state stored in the hollow portion of the elastic tube 12. The SMA actuator 1-1 according to the first embodiment is in a form in which the openings at the both ends of the elastic tube 12 are not sealed. Moreover, the oxidization film characteristics of the SMA wire 11 suppresses the energization of the refrigerant 13 that is the liquid metal.

In accordance with the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-1 can be increased. Moreover, no circulation apparatus that circulates the cooling for cooling the SMA wire 11 and the like is required. Therefore, the actuator can be downsized. Moreover, the elastic tube 12 expands and contracts in conjunction with the SMA wire 11. Therefore, the driving of the SMA wire 11 is not prohibited. SMA actuators 1-2 to 1-9 according to the second to ninth embodiments to be described below all have the features of the SMA actuator 1-1 according to the first embodiment.

### Second Embodiment of SMA Actuator

FIG. 3 is a cross-sectional view showing a configuration example of the second embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-2 according to the second embodiment in FIG. 3 includes an SMA wire 11, an elastic tube 12, a refrigerant 13, and sealing members 21 and 22. Therefore, the SMA actuator 1-2 in FIG. 3 is common to the SMA actuator 1-1 in FIGS. 1 and 2 in that it includes the SMA wire 11, the elastic tube 12, and the refrigerant 13. It should be noted that the SMA actuator 1-2 in FIG. 3 is different from the SMA actuator 1-1 in FIGS. 1 and 2 in that the sealing members 21 and 22 are newly provided.

In the SMA actuator 1-2 in FIG. 3, the sealing members 21 and 22 are formed of an elastic material and seal openings at two end portions of the elastic tube 12, respectively. The sealing members 21 and 22 may be, for example, an elastic adhesive. Moreover, the sealing members 21 and 22 are fixed to the SMA wire 11. Therefore, in conjunction with expansion and contraction of the SMA wire 11, the elastic tube 12 also expands and contracts.

In accordance with the SMA actuator 1-2, the hollow portion of the elastic tube 12 is hermetically sealed and the refrigerant 13 is prevented from leaking out of the hollow portion. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-2 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Third Embodiment of SMA Actuator

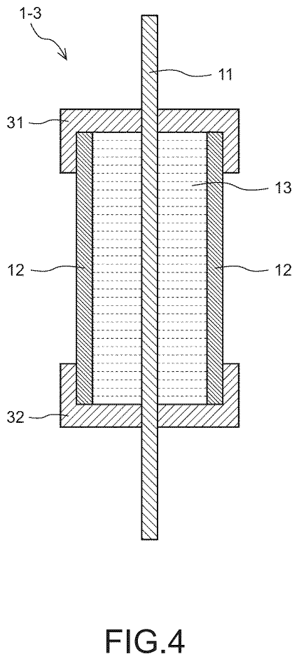

FIG. 4 is a cross-sectional view showing a configuration example of the third embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-3 according to the third embodiment in FIG. 4 includes an SMA wire 11, an elastic tube 12, a refrigerant 13, and sealing members 31 and 32. Therefore, the SMA actuator 1-3 in FIG. 4 is common to the SMA actuator 1-1 in FIGS. 1 and 2 in that it includes the SMA wire 11, the elastic tube 12, and the refrigerant 13. It should be noted that the SMA actuator 1-3 in FIG. 4 is different from the SMA actuator 1-1 in FIGS. 1 and 2 in that the sealing members 31 and 32 are newly provided.

In the SMA actuator 1-3 in FIG. 4, the sealing members 31 and 32 are formed of an elastic material and seal openings at both ends of the elastic tube 12, respectively. The sealing members 31 and 32 are fixed to end portions of the elastic tube 12 so as to cover areas of from the end portions of the elastic tube 12 to some points of the outer circumferential surface. Moreover, the sealing members 31 and 32 are fixed to the SMA wire 11. Therefore, in conjunction with expansion and contraction of the SMA wire 11, the elastic tube 12 also expands and contracts. In accordance with the SMA actuator 1-3, the hollow portion of the elastic tube 12 is hermetically sealed and the refrigerant 13 is prevented from leaking out of the hollow portion. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-3 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Fourth Embodiment of SMA Actuator

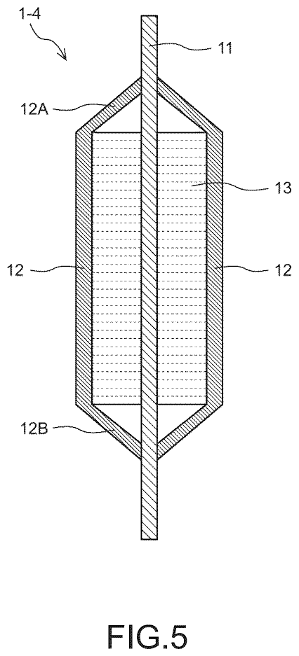

FIG. 5 is a cross-sectional view showing a configuration example of the fourth embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-4 according to the fourth embodiment in FIG. 5 includes an SMA wire 11, an elastic tube 12, a refrigerant 13, and sealing ends 12A and 12B. Therefore, the SMA actuator 1-4 in FIG. 5 is common to the SMA actuator 1-1 in FIGS. 1 and 2 in that it includes the SMA wire 11, the elastic tube 12, and the refrigerant 13. It should be noted that the SMA actuator 1-4 in FIG. 5 is different from the SMA actuator 1-1 in FIGS. 1 and 2 in that the sealing ends 12A and 12B are newly provided.

In the SMA actuator 1-4 in FIG. 5, the sealing ends 12A and 12B are portions, which are obtained by deforming each of two end portions of the elastic tube 12 with heat or the like, and seal the openings, press-fitted to the SMA wire 11. The sealing ends 12A and 12B are fixed to the SMA wire 11. Therefore, in conjunction with expansion and contraction of the SMA wire 11, the elastic tube 12 also expands and contracts.

In accordance with the SMA actuator 1-4, the hollow portion of the elastic tube 12 is hermetically sealed and the refrigerant 13 is prevented from leaking out of the hollow portion. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-4 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Fifth Embodiment of SMA Actuator

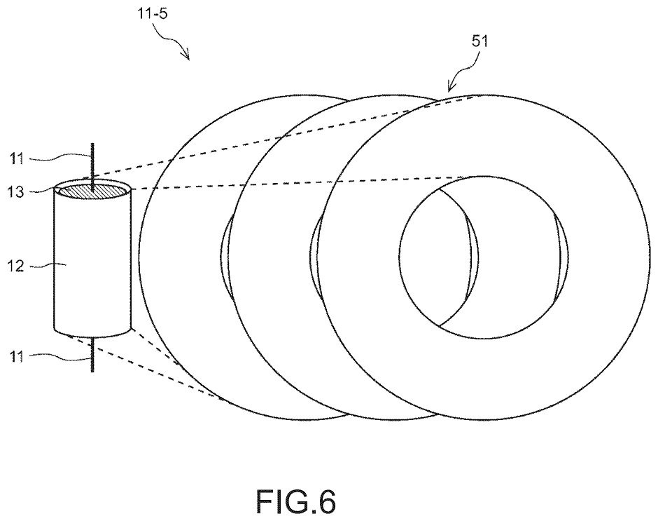

FIG. 6 is a cross-sectional view showing a configuration example of the fifth embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-5 according to the fifth embodiment in FIG. 6 includes an SMA wire 11, an elastic tube 12, a refrigerant 13, and an extension part 51. Therefore, the SMA actuator 1-5 is common to the SMA actuator 1-1 in FIGS. 1 and 2 in that the SMA actuator 1-5 in FIG. 6 includes the SMA wire 11, the elastic tube 12, and the refrigerant 13. It should be noted that the SMA actuator 1-5 in FIG. 6 is different from the SMA actuator 1-1 in FIGS. 1 and 2 in that the extension part 51 is newly provided.

In the SMA actuator 1-5 in FIG. 6, the extension part 51 is shown in a simplified structure. The extension part 51 is arranged around the elastic tube 12 and is constituted by a pipe member wound in, for example, a spiral form (coil form). The both ends of the pipe member of the extension part 51 are connected to the both ends of the elastic tube 12 and a hollow portion of the pipe member is in communication with the hollow portion of the elastic tube 12. Thus, the hollow portion of the pipe member of the extension part 51 is coupled to the hollow portion of the elastic tube 12 and forms an endless pipeline. Then, the refrigerant 13 is stored in the pipeline. It should be noted that the connection of the hollow portion of the elastic tube 12 and the hollow portion of the extension part 51 does not need to be performed at the both ends of the elastic tube 12. Alternatively, they may be connected at not two positions, but one or three or more positions.

The pipe member of the extension part 51 may be formed of an elastic material as in the elastic tube 12 or may be formed of a non-elastic material. Moreover, the extension part 51 may be formed of a material having a higher thermal conductivity, such as metal.

In accordance with the SMA actuator 1-5, the hollow portions of the elastic tube 12 and the extension part 51 are hermetically sealed and the refrigerant 13 is prevented from leaking out of the hollow portion. Moreover, heat of the refrigerant 13 is dissipated to the external air in a larger area due to the extension part 51. Therefore, heat dissipation of the heated SMA wire 11 to the refrigerant 13 increases in speed, and the temperature of the SMA wire 11 rapidly lowers. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-5 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Sixth Embodiment of SMA Actuator

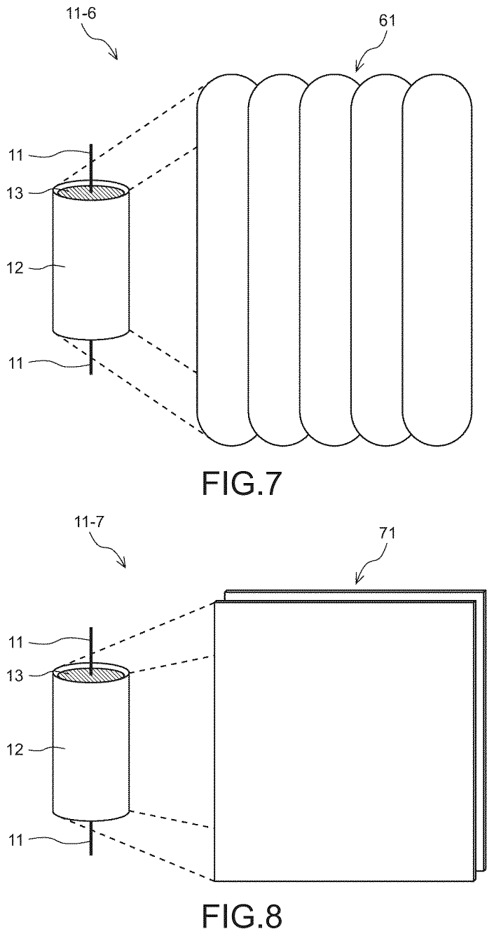

FIG. 7 is a cross-sectional view showing a configuration example of the sixth embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-6 according to the sixth embodiment in FIG. 7 includes an SMA wire 11, an elastic tube 12, a refrigerant 13, and an extension part 61. Therefore, the SMA actuator 1-6 in FIG. 7 is common to the SMA actuator 1-1 in FIGS. 1 and 2 in that it includes the SMA wire 11, the elastic tube 12, and the refrigerant 13. It should be noted that the SMA actuator 1-6 in FIG. 7 is different from the SMA actuator 1-1 in FIGS. 1 and 2 in that the extension part 61 is newly provided.

In the SMA actuator 1-6 in FIG. 7, the extension part 61 is shown in a simplified structure. The extension part 61 is arranged around the elastic tube 12, and for example, is constituted by a pipe member that reciprocates in one direction (up and down) along the plane while extending in the other direction (left and right). Both ends of a pipe member of the extension part 61 are connected to the both ends of the elastic tube 12 and a hollow portion of the pipe member is in communication with the hollow portion of the elastic tube 12. Thus, the hollow portion of the pipe member of the extension part 61 is coupled to the hollow portion of the elastic tube 12 and forms an endless pipeline. Then, the refrigerant 13 is stored in the pipeline. The connection of the hollow portion of the elastic tube 12 and the hollow portion of the extension part 61 does not need to be performed at the both ends of the elastic tube 12. Alternatively, they may be connected at not two positions, but one or three or more positions. The pipe member of the extension part 61 may be formed of an elastic material as in the elastic tube 12 or may be formed of a non-elastic material. Moreover, the extension part 61 may be formed of a material having a higher thermal conductivity, such as metal.

In accordance with the SMA actuator 1-6, the hollow portions of the elastic tube 12 and the extension part 61 are hermetically sealed and the refrigerant 13 is prevented from leaking out of the hollow portion. Moreover, heat of the refrigerant 13 is dissipated to the external air in a larger area due to the extension part 61. Therefore, heat dissipation of the heated SMA wire 11 to the refrigerant 13 increases in speed, and the temperature of the SMA wire 11 rapidly lowers. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-6 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Seventh Embodiment of SMA Actuator

FIG. 8 is a cross-sectional view showing a configuration example of the seventh embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-7 according to the seventh embodiment in FIG. 8 includes an SMA wire 11, an elastic tube 12, a refrigerant 13, and an extension part 71. Therefore, the SMA actuator 1-7 in FIG. 8 is common to the SMA actuator 1-1 in FIGS. 1 and 2 in that it includes the SMA wire 11, the elastic tube 12, and the refrigerant 13. It should be noted that the SMA actuator 1-7 in FIG. 8 is different from the SMA actuator 1-1 in FIGS. 1 and 2 in that the extension part 71 is newly provided.

In the SMA actuator 1-7 in FIG. 8, the extension part 71 is shown in a simplified structure. The extension part 71 is arranged around the elastic tube 12, and for example, is constituted by two flat plate-shaped wall surface members having a hollow portion (clearance) and a peripheral portion that seals the hollow portion at the periphery. It should be noted that the wall surface portions and the peripheral portion may be integrally formed. The hollow portion of the extension part 71 is, at any two positions, connected to the both ends of the elastic tube 12 via pipe-shaped coupling members, and the hollow portion of the extension part 71 is in communication with the hollow portion of the elastic tube 12. Thus, the hollow portion of the extension part 71 is coupled to the hollow portion of the elastic tube 12 and forms a hermetically sealed pipeline. Then, the refrigerant 13 is stored in the pipeline. It should be noted that the connection of the hollow portion of the elastic tube 12 and the hollow portion of the extension part 71 does not need to be performed at both ends of the elastic tube 12. Alternatively, they may be connected at not two positions, but one or three or more positions. The wall surface members and the peripheral portion (and the coupling members) of the extension part 71 may be formed of an elastic material as in the elastic tube 12 or may be formed of a non-elastic material. Moreover, the extension part 71 may be formed of a material having a higher thermal conductivity, such as metal.

In accordance with the SMA actuator 1-7, the hollow portions of the elastic tube 12 and the extension part 71 are hermetically sealed and the refrigerant 13 is prevented from leaking out of the hollow portion. Moreover, heat of the refrigerant 13 is dissipated to the external air in a larger area due to the extension part 71. Therefore, heat dissipation of the heated SMA wire 11 to the refrigerant 13 increases in speed, and the temperature of the SMA wire 11 rapidly lowers. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-7 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Eighth Embodiment of SMA Actuator

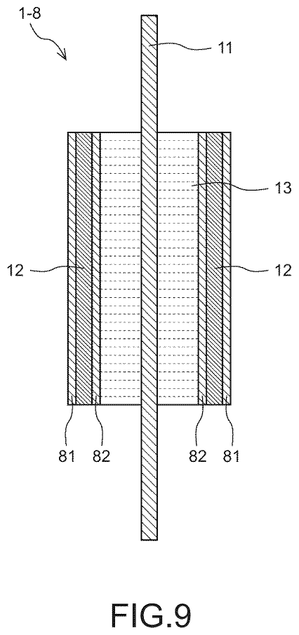

FIG. 9 is a cross-sectional view showing a configuration example of the eighth embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-8 according to the eighth embodiment in FIG. 9 includes an SMA wire 11, an elastic tube 12, a refrigerant 13, and heat guide parts 81 and 82. Therefore, the SMA actuator 1-8 in FIG. 9 is common to the SMA actuator 1-1 in FIGS. 1 and 2 in that it includes the SMA wire 11, the elastic tube 12, and the refrigerant 13. It should be noted that the SMA actuator 1-8 in FIG. 9 is different from the SMA actuator 1-1 in FIGS. 1 and 2 in that the heat guide parts 81 and 82 are newly provided.

In the SMA actuator 1-8 in FIG. 9, the heat guide parts 81 and 82 are adhered to the outer circumferential surface and the inner circumferential surface of the elastic tube 12 (an outer circumferential surface and an inner circumferential surface of a tubular body) in a thin film shape. The heat guide parts 81 and 82 are formed of, for example, a higher thermal conductive material (higher thermal conductive member), such as aluminum, in order to promote heat conduction. It should be noted that each of the heat guide parts 81 and 82 does not need to be provided in the entire surfaces of the outer circumferential surface and the inner circumferential surface of the elastic tube 12, may be provided in only one of the outer circumferential surface and the inner circumferential surface, or may be configured, for example, so that annular heat conduction members are arranged at constant intervals in the axis line direction.

In accordance with the SMA actuator 1-8, heat of the refrigerant 13 is easily dissipated to the external air due to the heat guide parts 81 and 82. Therefore, heat dissipation of the heated SMA wire 11 to the refrigerant 13 increases in speed, and the temperature of the SMA wire 11 rapidly lowers. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-8 can be increased. No circulation apparatus that circulates the cooling for cooling the SMA wire 11 is required. Therefore, the actuator can be downsized. Moreover, the elastic tube 12 expands and contracts in conjunction with the SMA wire 11. Therefore, the driving of the SMA wire 11 is not prohibited.

### Ninth Embodiment of SMA Actuator

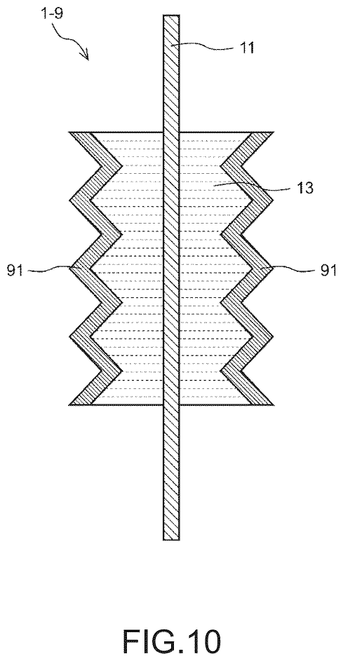

FIG. 10 is a cross-sectional view showing a configuration example of the ninth embodiment of the SMA actuator to which the present technology has been applied. It should be noted that in the figure, portions common to those of the SMA actuator 1-1 in FIGS. 1 and 2 are denoted by the same reference signs and descriptions thereof are omitted. An SMA actuator 1-9 according to the ninth embodiment in FIG. 10 includes an SMA wire 11, an elastic tube 91, and a refrigerant 13. Therefore, the SMA actuator 1-9 in FIG. 10 is common to the SMA actuator 1-1 in FIGS. 1 and 2 in that it includes the SMA wire 11 and the refrigerant 13. It should be noted that the SMA actuator 1-9 in FIG. 10 is different from the SMA actuator 1-1 in FIGS. 1 and 2 in that the elastic tube 91 is provided instead of the elastic tube 12 in FIGS. 1 and 2.

In the SMA actuator 1-9 in FIG. 10, the elastic tube 91 is the form of a tubular body shape (outer circumferential surface and inner circumferential surface) of the elastic tube 12 in the SMA actuator 1-1 in FIGS. 1 and 2. The elastic tube 91 (tubular body) has a bellows-shape shape and a contact area of the refrigerant 13 of the elastic tube 12 and the external air is increased.

In accordance with the SMA actuator 1-9, heat of the refrigerant 13 is easily dissipated to the external air due to the elastic tube 91. Therefore, heat dissipation of the heated SMA wire 11 to the refrigerant 13 increases in speed, and the temperature of the SMA wire 11 rapidly lowers. Moreover, as in the SMA actuator 1-1, the heated SMA wire 11 can be rapidly cooled by the refrigerant 13. Therefore, the cooling time required for the transformation from the austenite phase to the martensite phase can be reduced, and the operating speed of the SMA actuator 1-9 can be increased.

It should be noted that the present technology can have a configuration combining the first to ninth embodiments shown in FIGS. 1 to 10 as appropriate. Moreover, the SMA actuators 1-2 to 1-9 according to the second to ninth embodiments shown in FIGS. 3 to 10 have structures that can be employed as appropriate, considering the SMA actuator 1-1 in FIGS. 1 and 2 according to the first embodiment as one having a basic structure. Hereinafter, the SMA actuator 1-1 to 1-9 according to any embodiment of the first to ninth embodiments will be simply referred to as an SMA actuator 1, and it represents the SMA actuator 1-1 in FIGS. 1 and 2 unless otherwise stated.

### <Actions of Refrigerant>

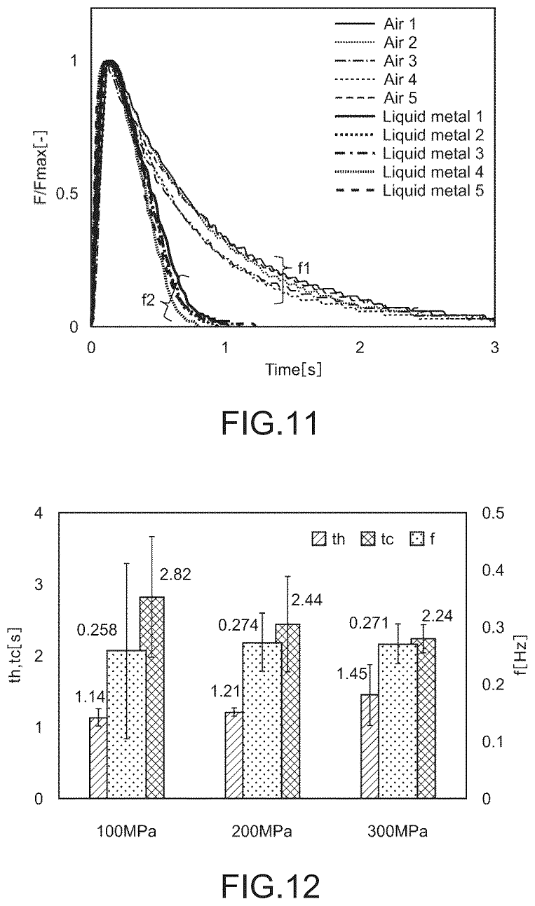

FIG. 11 is a graph showing differences in responsiveness depending on a type (material) of the refrigerant 13 of the SMA actuator 1. FIG. 11 shows actual measurement results of changes of a generated force F/Fmax (vertical axis) of the SMA wire 11 with respect to an elapsed time (horizontal axis) when the SMA actuator 1 (SMA wire 11) is energized off after a certain time after being energized. It should be noted that the generated force F/Fmax of the vertical axis represents a ratio of the generated force F with respect to the maximum generated force Fmax. In FIG. 11, graph lines f1 of “Air 1” to “Air 5” represent actual measurement results for five times in a case where air is used as the refrigerant 13. Graph lines f2 of “Liquid metal 1” to “Liquid metal 5” represent actual measurement results for five times in a case where a liquid metal is used as the refrigerant 13. According to this, the actual measurement results also shows that the responsiveness tends to be the same in a case where the type of refrigerant 13 is the same. The time until the generated force (F/Fmax) becomes maximum after being energized (0 seconds) is substantially the same, about 0.10 seconds, irrespective of the type of refrigerant 13. On the other hand, the tendence after being energized off when the generated force (F/Fmax) becomes maximum differs depending on the type of refrigerant 13. In a case where the refrigerant 13 is air, it is for about 3 seconds that the generated force (F/Fmax) becomes substantially zero. In a case where the refrigerant 13 is a liquid metal, it is for about 1 second that the generated force (F/Fmax) becomes substantially zero.

When the SMA wire 11 of the SMA actuator 1 becomes a higher temperature by self-heating due to energization, it undergoes a transformation (undergoes a reverse transformation) from the martensite phase to the austenite phase (parent phase) to recover to the memorized shape. When the SMA wire 11 of the SMA actuator 1 becomes a lower temperature by heat dissipation (cooling) due to the energization stopped, it undergoes a transformation from the austenite phase to the martensite phase to expand. As a result of the actual measurement as in FIG. 11, a result was obtained that in a case where the refrigerant 13 is either air or a liquid metal, the time required for the SMA wire 11 to become a temperature Af to completely change into the austenite phase from the martensite phase and end (a heating time th from a time at which it is energized) by heating due to energization is about 0.1 seconds.

On the other hand, a result was obtained that the time required for the SMA wire 11 to become a temperature Mf to completely change into the martensite phase from the austenite phase and end (a cooling time tc from a time at which it is energized off) by heat dissipation due to the energization stopped is about 1.72 seconds (with an error of 0.03 seconds) in a case where the refrigerant 13 is air while it is reduced to about 0.56 seconds (with an error of 0.03 seconds), which is about ⅓ thereof in a case where the refrigerant 13 is a liquid metal.

Therefore, it can be seen that in a case where the SMA wire 11 repeatedly transforms between the martensite phase and the austenite phase so that the SMA actuator 1 is periodically operated, an upper limit (maximum operating frequency f) of the operating frequency is 1/(0.1+1.72)=0.55 Hz in a case where the refrigerant 13 is air while the speed is increased to 1/(0.1+0.56)=1.51 Hz, which is about three times thereof, in a case where the refrigerant 13 is a liquid metal. Not limited to the case where the SMA actuator 1 is periodically operated, the operating speed when the SMA wire 11 is cooled and transforms into the martensite phase from the austenite phase is increased.

Using a fluid (material) having a higher thermal conductivity than the air as the refrigerant 13 in this manner can enhance the cooling effect of the SMA wire 11 by the refrigerant 13. The type of refrigerant 13 is not limited to the liquid metal. As long as it is a fluid (gas or liquid) having a higher thermal conductivity than the air, enhancement in the cooling effect of the SMA wire 11 and an increase in the operating speed of the SMA actuator 1 can be achieved without prohibiting the driving of the SMA wire 11.

### <Reduction in Cooling Time Depending on Preload (Preliminary Load)>

FIG. 12 is a diagram showing that the heating time th, the cooling time to, and the maximum operating frequency f of the SMA actuator 1 change in accordance with a magnitude of preload applied to the SMA actuator 1. The heating time th of the SMA actuator 1 is a time required for the SMA wire 11 to become a transformation temperature Af after a time at which the SMA wire 11 in the martensite phase is energized. The transformation temperature Af is a temperature at which the SMA wire 11 completely changes into the austenite phase from the martensite phase and ends, i.e., a temperature at which the transformation of the SMA wire 11 into the austenite phase from the martensite phase ends during heating. It should be noted that the heating time th obtained in the measurement is a time until the SMA wire 11 becomes the memorized shape (length), and it is not necessarily a time until it becomes the transformation temperature Af.

The cooling time tc of the SMA actuator 1 is a time required for the SMA wire 11 to become a transformation temperature Mf after a time at which the SMA wire 11 in the austenite phase is energized off. The transformation temperature Mf is a temperature at which the SMA wire 11 completely changes into the martensite phase from the austenite phase and ends, i.e., a temperature at which the transformation of the SMA wire 11 into the martensite phase from the austenite phase ends during cooling (during heat dissipation). It should be noted that the cooling time to obtained in the measurement is a time for the SMA wire 11 to have a shape (length) in the martensite phase, and it is not necessarily limited to a time until it becomes the transformation temperature Mc. The maximum operating frequency f is a maximum frequency in a case where the SMA actuator 1 is periodically operated and corresponds to 1/(time th+time tc).

FIG. 12 shows actual measurement results of the heating time th, the cooling time tc, the maximum operating frequency f in cases where the preload applied to the SMA actuator 1 is 100 MPa, 200 MPa, and 300 MPa. According to this, the larger the preload is, the shorter the cooling time tc is. The possible factors are that the transformation temperature Mf increased and that the strain rate increased because an increase in the preload increases the stress of the SMA wire 11. On the other hand, the larger the preload is, the longer the heating time th is. The possible factors are that the transformation temperatures As and Af increased and that the strain rate decreased because an increase in the preload increases the stress of the SMA wire 11. A transformation temperature As is a temperature at which the SMA wire 11 starts to change into the austenite phase from the martensite phase during heating, i.e., a temperature at which the transformation of the SMA wire 11 into the austenite phase from the martensite phase starts.

A result was obtained that in a case where the preload on the SMA actuator 1 is increased from such actual measurement results, the operating speed of the SMA actuator 1 can be increased because the cooling time to is reduced. Moreover, a result was obtained that the operating speed (operating frequency f) can be increased also in a case where the SMA actuator 1 is periodically operated. Therefore, adding the preload in addition to using a fluid having a higher thermal conductivity than the air as the refrigerant 13 of the SMA actuator 1 can achieve enhancement in the cooling effect of the SMA wire 11 and an increase in the operating speed of the SMA actuator 1.

### <Increase of Operating Speed of SMA Actuator 1>

If the preload on the SMA actuator 1 is increased in accordance with the measurement results FIG. 12, the cooling time tc is shortened, but the heating time th is prolonged. Therefore, in a case where the SMA actuator 1 is periodically operated (or not limited to the case of the periodic operation), an increase in the operating speed (operating frequency f) is prohibited for the prolonged time of the heating time th. In view of this, by adding only the preload in the heating time th and increasing the load on the SMA wire 11 only in the cooling time tc, the cooling time tc is shortened while preventing the heating time th from being prolonged, and an increase in the operating speed of the SMA actuator 1 is achieved.

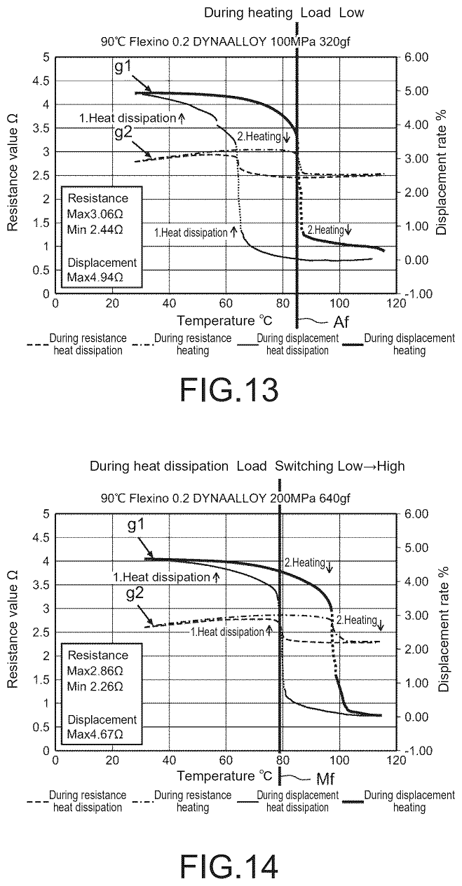

FIGS. 13 and 14 are diagrams illustrating actual measurement results of a relationship between the temperature of the SMA wire 11 (horizontal axis) and the displacement percentage (vertical axis) in a case where the load on the SMA wire 11 is 100 MPa (in a case of a lower load where the load is small) and in a case where it is 200 MPa (in a case of a higher load where the load is large). It should be noted that although in FIGS. 13 and 14, a relationship between the temperature of the SMA wire 11 and the displacement percentage is shown as a graph g1 and a relationship between the temperature of the SMA wire 11 and the resistance value is shown as a graph g2, the description of the relationship between the temperature and the resistance value is omitted. In each of FIGS. 13 and 14, the displacement percentage of the SMA wire 11 when the temperature rises during heating and a rate of change of the SMA wire 11 when the temperature drops during heat dissipation (during cooling) are shown. Describing it with rough temperatures, the transformation temperature Af is a temperature when the rate of change rapidly drops during heating, and the transformation temperature Mf is a temperature when the rate of change rapidly rises during heat dissipation. In a case where the load on the SMA wire 11 is 100 MPa (lower load), the transformation temperature Af is about 85° C. and the transformation temperature Mf is about 65° C. as in FIG. 13. In a case where the load on the SMA wire 11 is 200 MPa (higher load), the transformation temperature Af is about 95° C. and the transformation temperature Mf is about 80° C. as in FIG. 14.

The lower the transformation temperature Af is, the shorter the heating time th is. The higher the transformation temperature Mf is, the shorter the cooling time tc is.

Therefore, the load on the SMA wire 11 is set to 100 MPa (lower load) during heating as in FIG. 13 and the load on the SMA wire 11 is set to 200 MPa (higher load) as in FIG. 14 during heat dissipation. Accordingly, the operating speed (operating frequency) or the SMA actuator can be increased. It should be noted that the load values in cases of a lower load and a higher load in FIGS. 12 and 13 are examples, and the present technology is not limited thereto.

### <Configuration Example of Control System of SMA Actuator 1>

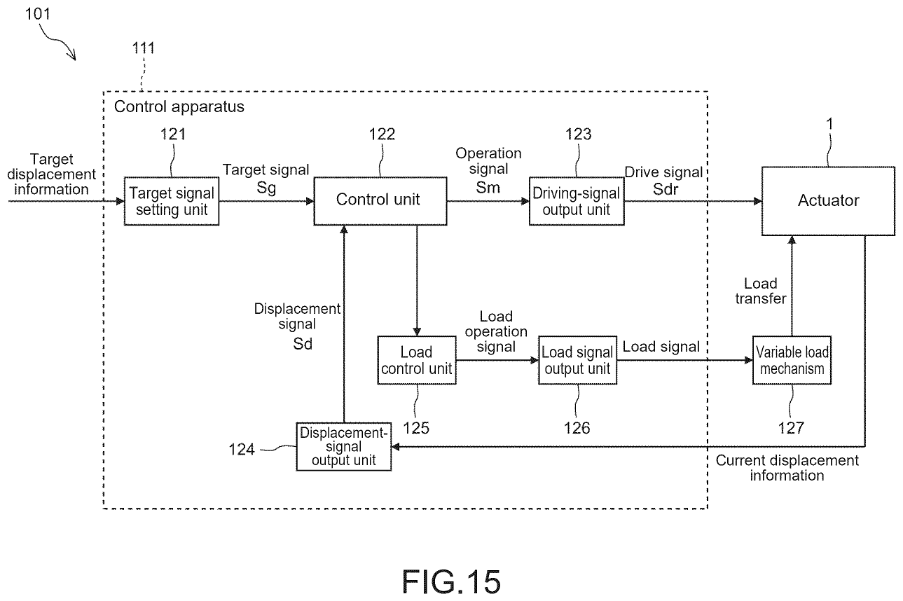

FIG. 15 is a block diagram showing a configuration example of a control system that switches the load on the SMA actuator 1 for increasing in the operating speed. In FIG. 15, a control system 101 that controls the SMA actuator 1 includes an SMA actuator 1 and an control apparatus 111. The control apparatus 111 controls the supply of an electric current to the SMA wire 11 from the SMA actuator 1 and also controls the load on the SMA wire 11. The control apparatus 111 includes a target signal setting unit 121, a control unit 122, a driving signal output unit 123, a displacement signal output unit 124, a load control unit 125, and a load signal output unit 126.

Given target displacement information indicating a target displacement value of the SMA actuator 1 from the outside, the target signal setting unit 121 considers the displacement value as a target displacement value of the SMA actuator 1 and supplies the control unit 122 with a target signal Sg indicating the target displacement value. The control unit 122 generates an operation signal Sm on the basis of the target signal Sg from the target signal setting unit 121 and a displacement signal Sd indicating a current displacement value of the SMA actuator 1 from the displacement signal output unit 124, and supplies it to the driving signal output unit 123. The operation signal Sm is a signal indicating the direction, the magnitude, and the like to displace the SMA actuator 1 so that the target displacement value of the SMA actuator 1 is equal to the current displacement value.

Moreover, the control unit 122 supplies the operation signal Sm to the load control unit 125. On the basis of the operation signal Sm from the control unit 122, the driving signal output unit 123 supplies the SMA actuator 1 with a driving signal Sdr for driving the SMA actuator 1. If the direction to displace the SMA actuator 1 is a direction to heat the SMA wire 11, the driving signal Sdr is a signal for applying an electric current or voltage for energizing the SMA wire 11 to the SMA wire 11. In accordance with the magnitude to displace the SMA actuator 1, the magnitude of the driving signal Sdr (the magnitude of the electric current or voltage applied to SMA wire 11) may be changed. If the direction to displace the SMA actuator 1 is a direction to cool the SMA wire 11, the driving signal Sdr is a signal for energizing off the SMA wire 11 and is a signal for making the electric current or voltage zero. The SMA actuator 1 is displaced in a direction to obtain the target displacement value in accordance with the driving signal Sdr from the driving signal output unit 123. The displacement signal output unit 124 acquires current displacement information indicating the current displacement value of the SMA actuator 1 from a sensor provided in the SMA actuator 1 and supplies a displacement signal Sd indicating the displacement value to the control unit 122. The load control unit 125 generates a load operation signal on the basis of the operation signal Sm from the control unit 122 and supplies it to the load signal output unit 126. If the direction to displace the SMA actuator 1 is a direction to heat the SMA wire 11, the load operation signal is a signal for making an instruction to decrease the load on the SMA actuator 1. If the direction to displace the SMA actuator 1 is a direction to cool the SMA wire 11, the load operation signal is a signal for making an instruction to increase the load on the SMA actuator 1.

The load signal output unit 126 supplies a variable load mechanism 127 with the load signal on the basis of the load operation signal from the load control unit 125. The variable load mechanism 127 includes a mechanical mechanism and switches between two states, for example, in accordance with a voltage in the load signal, the two states including an on-state in which a load is added to the SMA wire 11 and an off-state in which no load is added to the SMA wire 11. Although details of the specific configuration are omitted, the variable load mechanism 127 switches between the state (contact state) in which the SMA wire 11 and a link member (contact member) are held in contact and the state (contactless state) in which the SMA wire 11 and a link member (contact member) are not held in contact, in the on-state and the off-state. A biasing force is added to the link member, and in the contact state, a load is added to the SMA wire 11 via the link member. In the contactless state, no load is added to the SMA wire 11 via the link member. In a case where the load operation signal from the load control unit 125 is a signal for make an instruction to decrease the load on the SMA actuator 1, the load signal output unit 126 puts the variable load mechanism 127 in the off-state in which no load is added to the SMA wire 11 in accordance with a load signal supplied to the variable load mechanism 127. In a case where the load operation signal from the load control unit 125 is a signal for make an instruction to increase the load on the SMA actuator 1, the load signal output unit 126 puts the variable load mechanism 127 in the on-state in which a load is added to the SMA wire 11 in accordance with a load signal supplied to the variable load mechanism 127.

In accordance with the control system 101 in FIG. 15, the load on the SMA wire 11 becomes a lower load during heating of the SMA actuator 1 (SMA wire 11) and the load on the SMA wire 11 becomes a higher load during cooling of the SMA actuator 1 (SMA wire 11). Therefore, the operation of the SMA actuator 1 is increased in speed. Not limited to the case where the SMA actuator 1 is controlled by the periodic operation, the displacement itself of the SMA actuator 1 is rapid, which can increase the operating speed.

### <Procedure Example of Control Processing of SMA Actuator 1>

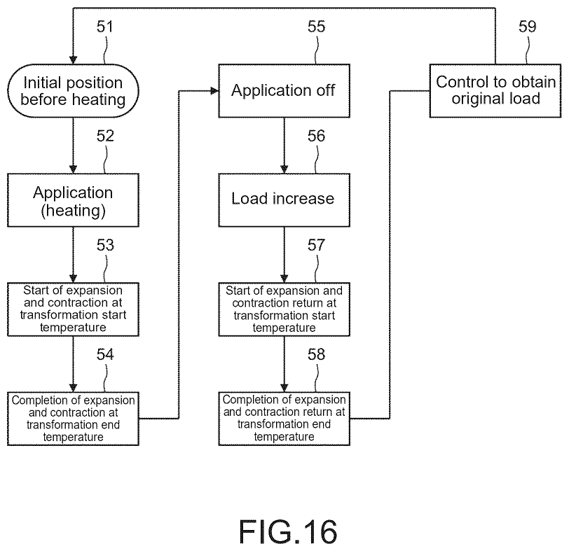

FIG. 16 is a flow diagram showing a procedure example of control processing of the SMA actuator 1 in the control system 101 in FIG. 15. It should be noted that the control apparatus 111 performs all processes for the respective functional blocks in the control apparatus 111. In FIG. 16, the processing in Steps S1 to S9 is repeated. In Step S1, the SMA actuator 1 is in an initial position before heating (state in which SMA wire 11 is in the martensite phase). In Step S2, the control apparatus 111 energizes the SMA wire 11 by applying an electric current or voltage to the SMA wire 11. Accordingly, the SMA wire 11 starts heating by self-heating. In Step S3, the temperature of the SMA wire 11 rises, and the SMA wire 11 reaches a start temperature (transformation temperature As) of the transformation from the martensite phase to the austenite phase. Accordingly, the SMA wire 11 starts expansion and contraction (contraction). In Step S4, the temperature further rises and the SMA wire 11 reaches an end temperature (transformation temperature Af) of the transformation from the martensite phase to the austenite phase. Accordingly, the SMA wire 11 ends expansion and contraction (contraction). In Step S5, the control apparatus 111 stops the application of an electric current or voltage to the SMA wire 11 and energizes off the SMA wire 11. Accordingly, the cooling (heat dissipation) of the SMA wire 11 starts. In Step S6, the control apparatus 111 increases the load on the SMA wire 11. In Step S7, the temperature of the SMA wire 11 drops and the SMA wire 11 reaches a start temperature (transformation temperature Ms) of the transformation from the austenite phase to the martensite phase. Accordingly, the SMA wire 11 starts expansion and contraction (expansion) (expansion and contraction return start). In Step S8, the temperature further drops and the SMA wire 11 reaches an end temperature (transformation temperature Mf) of the transformation from the austenite phase to the martensite phase. Accordingly, the SMA wire 11 ends expansion and contraction (expansion) (expansion and contraction return end). In Step S9, the control apparatus 111 controls the load on the SMA wire 11 to be the original load (removes the increase in load in Step S6). The processing returns to Step S1 after Step S9. The processing in Steps S1 to S9 is repeated.

### COMBINATION EXAMPLES OF CONFIGURATIONS

It should be noted that the present technology can also take the following configurations.
(1) An actuator, including:
   a wire formed of a shape memory alloy;
   a tubular member in which the wire is arranged to pass through a hollow portion; and
   a refrigerant that is a fluid stored in the hollow portion.
(2) The actuator according to (1), in which
   the wire has a linear shape.
(3) The actuator according to (1) or (2), in which
   the wire is energized by applying an electric current or voltage.
(4) The actuator according to any of (1) to (3), in which
   the tubular member has elasticity.
(5) The actuator according to any of (1) to (4), in which
   the tubular member is formed of a silicone resin.
(6) The actuator according to any of (1) to (5), in which
   the tubular member maintains a state in which the refrigerant is stored in the hollow portion by capillary action.
(7) The actuator according to any of (1) to (5), in which
   the tubular member whose openings at both ends are sealed in a state in which the refrigerant is stored in the hollow portion.
(8) The actuator according to any of (1) to (7), further including
   an extension part that is formed outside the tubular member for heat dissipation, is in communication with the hollow portion of the tubular member, and includes a hollow portion in which the refrigerant is stored.
(9) The actuator according to any of (1) to (8), in which
   a member that promotes heat conduction is arranged on at least one of an inner circumferential surface or an outer circumferential surface of the tubular member.
(10) The actuator according to any of (1) to (9), in which
   the tubular member has a bellows-shape shape.
(11) The actuator according to any of (1) to (10), in which
   the refrigerant is a fluid having a higher thermal conductivity than air.
(12) The actuator according to any of (1) to (11), in which
   the refrigerant is a liquid metal.
(13) The actuator according to any of (1) to (12), in which
   the refrigerant is a gallium-indium-tin alloy.
(14) The actuator according to any of (1) to (13), in which
   to the wire, a preload is applied.
(15) The actuator according to any of (1) to (14), in which
   to the wire, a load is added during cooling.
(16) The actuator according to (15), in which
   from the wire, the load is removed during heating.
(17) An actuator drive method for driving an actuator including a wire formed of a shape memory alloy, a tubular member in which the wire is arranged to pass through a hollow portion, and a refrigerant that is a fluid stored in the hollow portion, including:
   a first step of energizing the wire;
   a second step of energizing off the wire when the wire undergoes a reverse transformation;
   a third step of increasing a load on the wire; and
   a fourth step of removing the increase in load in the third step when the wire undergoes a transformation.

### REFERENCE SIGNS LIST

1-1 to 1-9 SMA actuator
11 SMA wire
12 elastic tube
12A, 12B sealing end
13 refrigerant
21 sealing member
31, 32 sealing member
51 extension part
61 extension part
71 extension part
81 heat guide part
91 elastic tube
101 control system
111 control apparatus
121 target signal setting unit
122 control unit
123 driving signal output unit
124 displacement signal output unit
125 load control unit
126 load signal output unit
127 variable load mechanism

1. An actuator, comprising:
a wire formed of a shape memory alloy;
a tubular member in which the wire is arranged to pass through a hollow portion; and
a refrigerant that is a fluid stored in the hollow portion.

2. The actuator according to claim 1, wherein
the wire has a linear shape.

3. The actuator according to claim 1, wherein
the wire is energized by applying an electric current or voltage.

4. The actuator according to claim 1, wherein
the tubular member has elasticity.

5. The actuator according to claim 1, wherein
the tubular member is formed of a silicone resin.

6. The actuator according to claim 1, wherein
the tubular member maintains a state in which the refrigerant is stored in the hollow portion by capillary action.

7. The actuator according to claim 1, wherein
the tubular member whose openings at both ends are sealed in a state in which the refrigerant is stored in the hollow portion.

8. The actuator according to claim 1, further comprising
an extension part that is formed outside the tubular member for heat dissipation, is in communication with the hollow portion of the tubular member, and includes a hollow portion in which the refrigerant is stored.

9. The actuator according to claim 1, wherein
a member that promotes heat conduction is arranged on at least one of an inner circumferential surface or an outer circumferential surface of the tubular member.

10. The actuator according to claim 1, wherein
the tubular member has a bellows-shape shape.

11. The actuator according to claim 1, wherein
the refrigerant is a fluid having a higher thermal conductivity than air.

12. The actuator according to claim 1, wherein
the refrigerant is a liquid metal.

13. The actuator according to claim 1, wherein
the refrigerant is a gallium-indium-tin alloy.

14. The actuator according to claim 1, wherein
to the wire, a preload is applied.

15. The actuator according to claim 1, wherein
to the wire, a load is added during cooling.

16. The actuator according to claim 15, wherein
from the wire, the load is removed during heating.

17. An actuator drive method for driving an actuator including a wire formed of a shape memory alloy, a tubular member in which the wire is arranged to pass through a hollow portion, and a refrigerant that is a fluid stored in the hollow portion, comprising:
a first step of energizing the wire;
a second step of energizing off the wire when the wire undergoes a reverse transformation;
a third step of increasing a load of the wire; and
a fourth step of removing the increase in load in the third step when the wire undergoes a transformation.
